(19) United States
(12) Patent Application Publication
(10) Pub. No.: US 2020/0297565 A1
(43) Pub. Date: Sep. 24, 2020

(54) HOSPITAL BED LIFT ASSEMBLY

(71) Applicant: Larry McIntosh, D'Iberville, MS (US)

(72) Inventor: Larry McIntosh, D'Iberville, MS (US)

(21) Appl. No.: 16/359,691

(22) Filed: Mar. 20, 2019

(51) Int. Cl. A61G 7/10

(52) U.S. Cl. CPC A61G 7/1019; A61G 7/1025; A61G 2200/34; A61G 7/1073; A61G 2200/32

(57) ABSTRACT

A hospital bed lift assembly for transferring a user into and out of a bed includes a cart that is rollable along a support surface and is positionable adjacent to a bed for sleeping. A control circuit is coupled to the cart, a lift is coupled to the cart and the lift is electrically coupled to the control circuit. A chair is pivotally coupled to the lift for lifting a user when the user sits in the chair. In this way the user can drop downwardly onto the bed when the user is transferred into the bed. A pair of members is each pivotally coupled to the cart. Each of the members extends forwardly from the cart to inhibit the user from tipping the cart forwardly when the user is lifted in the chair.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to lift devices and more particularly pertains to a new lift device for transferring a user into and out of a bed.

### BRIEF SUMMARY OF THE INVENTION

An embodiment of the disclosure meets the needs presented above by generally comprising a cart that is rollable along a support surface for positioning adjacent to a bed for sleeping. A control circuit is coupled to the cart, a lift is coupled to the cart and the lift is electrically coupled to the control circuit. A chair is pivotally coupled to the lift for lifting a user when the user sits in the chair. In this way the user can drop downwardly onto the bed when the user is transferred into the bed. A pair of members is each pivotally coupled to the cart. Each of the members extends forwardly from the cart to inhibit the user from tipping the cart forwardly when the user is lifted in the chair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a hospital bed lift assembly according to an embodiment of the disclosure.

FIG. 2 is a left side view of an embodiment of the disclosure.

FIG. 3 is a top phantom view of an embodiment of the disclosure.

FIG. 4 is a back phantom view of an embodiment of the disclosure.

FIG. 5 is a perspective in-use view of an embodiment of the disclosure.

### DETAILED DESCRIPTION OF THE INVENTION

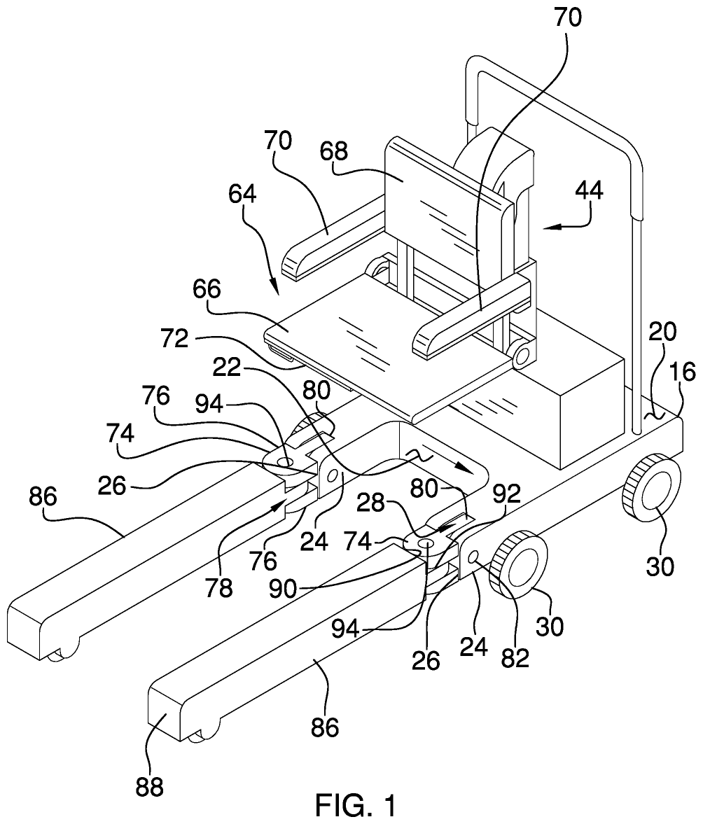

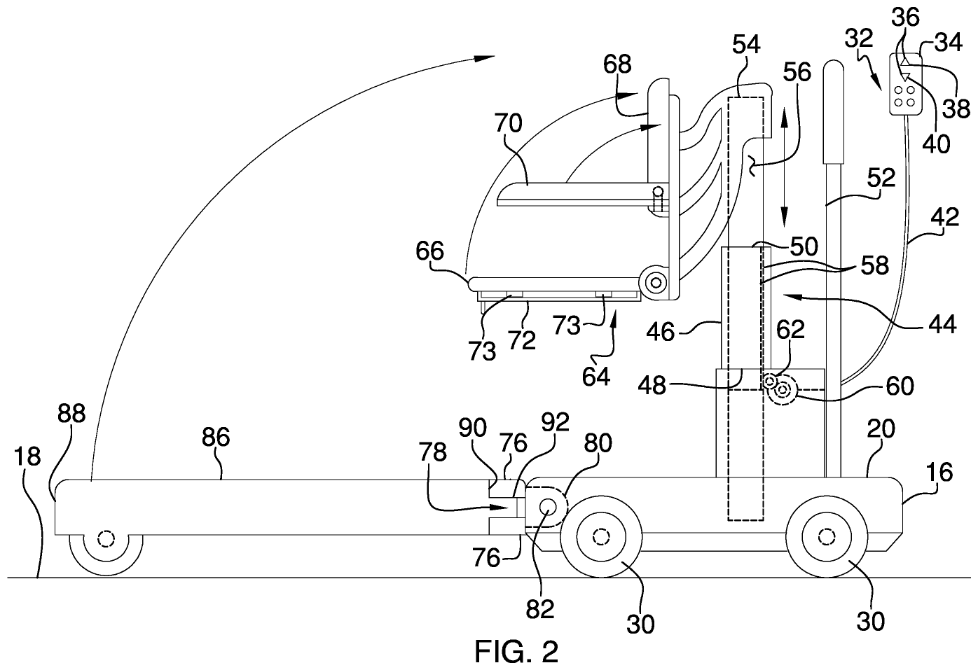

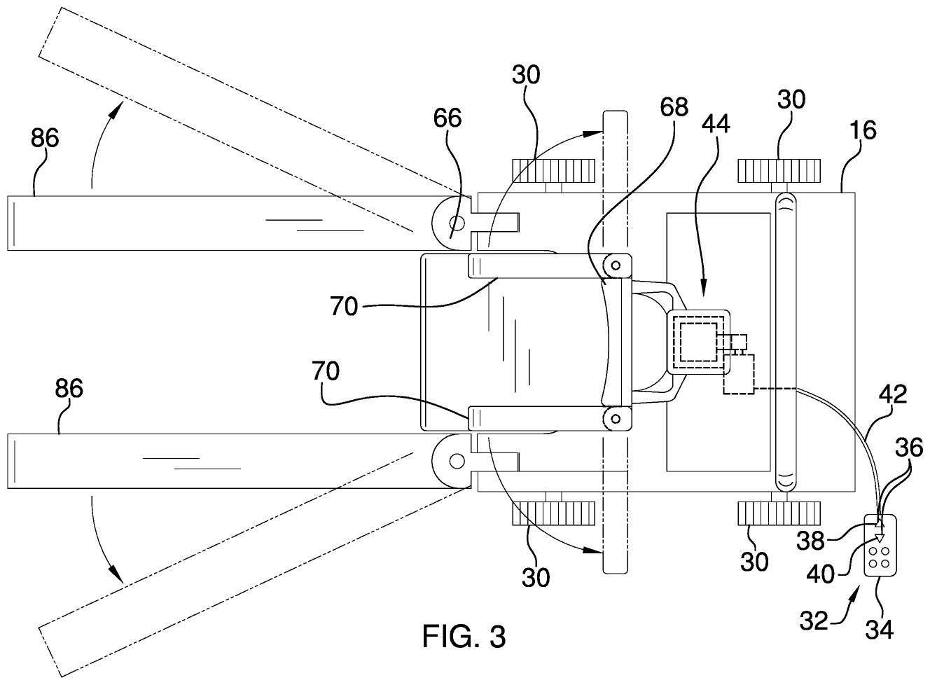

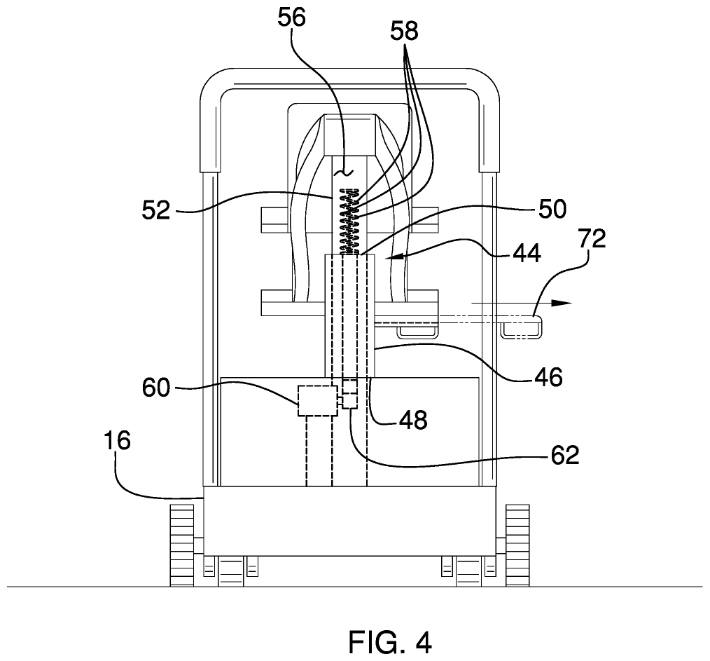

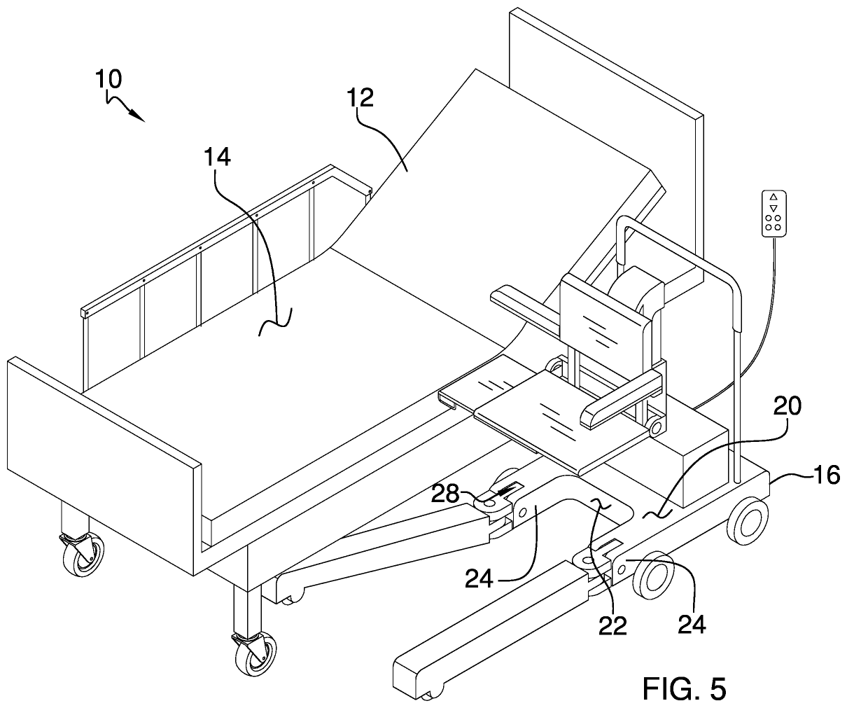

With reference now to the drawings, and in particular to FIGS. 1 through 5 thereof, a new lift device embodying the principles and concepts of an embodiment of the disclosure and generally designated by the reference numeral 10 will be described.

As best illustrated in FIGS. 1 through 5, the hospital bed lift assembly 10 generally comprises a bed 12 for sleeping that has an upper surface 14. The bed 12 may be a hospital bed, a bed in a residential bedroom and any other type of elevated bed. A cart 16 is rollable along a support surface 18 and the cart 16 is positionable adjacent to and extending beneath the bed 12. The cart 16 has a top surface 20 and a front surface 22, and the front surface 22 has a pair of arms 24 each extending forwardly therefrom. Each of the arms 24 has a distal end 26 with respect to the front surface 22 and the distal end 26 of each of the arms 24 has a slot 28 extending toward the front surface 22. The arms 24 are spaced apart from each other on the front surface 22 of the cart 16.

A plurality of cart rollers 30 is each rotatably coupled to the cart 16 for rolling along the supports surface 18. A control circuit 32 is coupled to the cart 16 and the control circuit 32 includes a control panel 34 that has a plurality of buttons 36 thereon. The plurality of buttons 36 at least includes an up button 38 and a down button 40. Moreover, the control panel 34 may be remotely positioned from the cart 16 and a conductor 42 may be electrically coupled between the control panel 34 and the control circuit 32.

A lift 44 is movably coupled to the cart 16 and the lift 44 is electrically coupled to the control circuit 32. The plurality of buttons 36 controls operational parameters of the lift 44. The lift 44 comprises a sleeve 46 that has a first end 48 and a second end 50. The first end 48 is coupled to the top surface 20 of the cart 16 having the sleeve 46 being vertically oriented. A pole 52 is slidably positioned in the sleeve 46 and the pole 52 has a top end 54 and an outer surface 56. The top end 54 is exposed with respect to the sleeve 46 and the outer surface 56 has a plurality of indentations 58 thereon. The indentations 58 are spaced apart from each other and are vertically distributed along the pole 52.

A motor 60 is coupled to the cart 16 and the motor 60 is electrically coupled to the control circuit 32. The motor 60 is turned on to rotate in a first direction when the up button 38 on the control panel 34 is manipulated. Additionally, the motor 60 is turned on to rotate in a second direction when the down button 40 on the control panel 34 is manipulated. A gear 62 is rotatably coupled to the motor 60 such that the motor 60 rotates the gear 62 when the motor 60 is turned on and the gear 62 engages the indentations 58 in the pole 52. Thus, the pole 52 is urged upwardly in the sleeve 46 when the motor 60 is actuated to rotate in the first direction. Additionally, the pole 52 is urged downwardly in the sleeve 46 when the motor 60 is actuated to rotate in the second direction. The motor 60 may be an electric motor or the like. A power supply 62 is coupled to the cart 16 and the power supply 62 is electrically coupled to the control circuit 32. The power supply 62 comprises at least one battery.

A chair 64 is pivotally coupled to the lift 44 to lift a user when the user sits in the chair 64. The chair 64 can be fully lowered to the ground thereby facilitating the user to be positioned in the chair 64 when the user is lying on the ground. The user may be a physically disabled user, an injured user or any other user that is either not ambulatory or has limited movement. The chair 64 is spaced above the upper surface 14 of the bed 12 when the chair 64 is lifted. In this way the user can drop downwardly onto the upper surface 14 of the bed 12 when the user is transferred into the bed 12.

The chair 64 has a seat portion 66 that is pivotally coupled to a backrest portion 68. The backrest portion 68 has attachments 69 each angling upwardly and rearwardly away therefrom. Each of the attachments 69 is each attached to the top end 54 of the pole 52. The backrest portion 68 is spaced forwardly from the pole 52 having the backrest portion 68 being vertically oriented. The seat portion 66 is aligned with a lower edge of the backrest portion 68 and the seat portion 66 is positionable in a stored position having the seat portion 66 lying against the backrest portion 68. The seat portion 66 is positioned between each of the arms 24 on the front surface 22 of the cart 16 when the lift 44 is fully lowered thereby making it easier to position a non-ambulatory user in the chair 64.

A pair of arm rests 70 is provided and each of the arm rests 70 is pivotally coupled to the backrest portion 68 of the chair 64. Each of the arm rests 70 is spaced upwardly from the seat portion 66. Additionally, each of the arm rests 70 is positionable in a stored position having each of the arm rests 70 lying against the backrest portion 68. Each of the arm rests 70 can be pivoted laterally with respect to the chair 64. The chair 64 includes a seat belt 71 for securing the user in the chair 64 during lifting and lowering

A shelf 72 is provided and the shelf 72 is slidably coupled to the chair 64. The shelf 72 is positionable in an extended position extending laterally away from the chair 64. Thus, the user can be positioned on the shelf 72 to assist with sliding the user from the chair 64 onto the upper surface 14 of the bed 12. Moreover, the shelf 72 can be slid either to the right or to the left of the chair 64.

The shelf 72 includes a plurality of stops 73 that each engage the chair 64 to inhibit the shelf 72 from being extended so far as to be removed from the chair 64. The shelf 72 is slidably coupled to a bottom surface of the seat portion 66 of the chair 64. The shelf 72 is positioned beneath the seat portion 66 when the shelf 72 is positioned in a stored position. The shelf 72 may include a hinged section that is downwardly pivotable on the shelf 72. Thus, the hinged section of the shelf 72 can be downwardly pivoted to drop the user onto the bed 12 when the user is positioned on the shelf 72. The hinged section on the shelf 72 may have a depth of approximately 9.0 inches.

A pair of pivots 74 is provided and each of the pivots 74 is pivotally coupled to the cart 16. Each of the pivots 74 has a pair of first panels 76 that are spaced apart from each other to define a coupling space 78 between the first panels 76. Each of the pivots 74 has a second panel 80 extending away from each of the first panels 76. The second panel 80 of each of the pivots 74 is positioned in the slot 28 in a respective one of the arms 24 on the cart 16 having the second panel 80 of each of the pivots 74 being horizontally oriented. A pair of first pins 82 each extends laterally through a respective one of the arms 24 and engages the second panel 80 in the slot 28 in the respective arm 24. Thus, each of the pivots 74 is pivotable about the respective first pin.

A pair of members 86 is provided and each of the members 86 is pivotally coupled to the cart 16. Each of the members 86 extends forwardly from the cart 16 to inhibit the user from tipping the cart 16 forwardly when the user is lifted in the chair 64. Each of the members 86 has a primary end 88 and a secondary end 90. The secondary end 90 of each of the members 86 has a flattened section 92 extending into the coupling space 78 in a respective one of the pivots 74. Moreover, each of the members 86 is upwardly pivotable on the cart 16 when the pivots 74 are pivoted about the first pins 82. Additionally, each of the members 86 is laterally pivotable in the respective pivot 74. Additionally, the members 86 are spaced apart from each other a distance that is greater than a width of the chair 64. In this way the chair 86 can be fully lowered to the ground having the chair 86 being positioned between the members 86.

A pair of second pins 94 each extends through the first panels 76 of a respective one of the pivots 74 and engages the flattened section 92 of a respective one of the members 86. Thus, the respective member 86 is pivotally coupled to the respective pivot 74. A plurality of member rollers 96 is each rotatably coupled to and extends downwardly from a respective one of the members 86. Each of the member rollers 96 is aligned with the primary end 88 of the respective member and each of the member rollers 96 rolls along the support surface 18.

In use, the lift 44 is fully lowered to facilitate the user to be positioned on the seat portion 66 of the chair 64. The lift 44 is raised until the seat portion 66 of the chair 64 is raised above the support surface 18. The cart 16 and members 86 are rolled along the support surface 18 to position the user alongside the bed 12. One of the members 86 that is adjacent to the bed 12 is pivoted laterally to extend under the bed 12 for laterally stabilizing the cart 16. The lift 44 is manipulated to lift the user above the upper surface 14 of the bed 12. The arm rests 70 are positioned in the stored position and the user is slid laterally off of the seat portion 66 and onto the bed 12. Additionally, the shelf 72 that is aligned with the bed 12 can be extended for assisting sliding the user over the bed 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hospital bed lift assembly being configured to transfer a patient into and out of a hospital bed, said assembly comprising:
a cart being rollable along a support surface, said cart being positionable adjacent to a hospital bed and extending beneath the bed;
a control circuit being coupled to said cart;
a lift being coupled to said cart, said lift being electrically coupled to said control circuit;
a chair being pivotally coupled to said lift wherein said chair is configured to lift a user when the user sits in said chair, said chair being spaced above an upper surface of the bed when said chair is lifted wherein said chair is configured to facilitate the user to drop downwardly onto the upper surface of the bed when the user is transferred into the bed;
a plurality of cart rollers, each of said cart rollers being rotatably coupled to said cart for rolling along the support surface; and
a pair of members, each of said members being pivotally coupled to said cart, each of said members extending forwardly from said cart wherein each of said members is configured to inhibit the user from tipping said cart forwardly when the user is lifted in said chair.

2. The assembly according to claim 1, wherein said cart has a top surface and a front surface, said front surface having a pair of arms each extending forwardly therefrom, each of said arms having a distal end with respect to said front surface, said distal end of each of said arms having a slot extending toward said front surface.

3. The assembly according to claim 2, wherein said lift comprises:
a sleeve having a first end and a second end, said first end being coupled to said top surface of said cart having said sleeve being vertically oriented; and
a pole being slidably positioned in said sleeve, said pole having a top end and an outer surface, said top end being exposed with respect to said sleeve, said outer surface having a plurality of indentations thereon, said indentations being spaced apart from each other and being vertically distributed along said pole.

4. The assembly according to claim 3, wherein:
said control circuit includes a control panel having a plurality of buttons thereon, said plurality of buttons at least including an up button and a down button; and
said lift comprises:
a motor being coupled to said cart, said motor being electrically coupled to said control circuit, said motor being turned on to rotate in a first direction when said up button on said control panel is manipulated, said motor being turned on to rotate in a second direction when said down button on said control panel is manipulated; and
a gear being rotatably coupled to said motor such that said motor rotates said gear when said motor is turned on, said gear engaging said indentations in said pole, said pole being urged upwardly in said sleeve when said motor is actuated to rotate in said first direction, said pole being urged downwardly in said sleeve when said motor is actuated to rotate in said second direction.

5. The assembly according to claim 4, further comprising a power supply being coupled to said cart, said power supply being electrically coupled to said control circuit, said power supply comprising at least one battery.

6. The assembly according to claim 4, wherein said chair has a seat portion being pivotally coupled to a backrest portion, said backrest portion having attachments each being attached to said top end of said pole, said back rest portion being spaced forwardly from said pole having said back rest portion being vertically oriented, said seat portion being aligned with a lower edge of said backrest portion, said seat portion being positionable in a stored position having said seat portion lying against said backrest portion.

7. The assembly according to claim 6, further comprising:
a pair of arm rests, each of said arm rests being pivotally coupled to said backrest portion of said chair, each of said arm rests being spaced upwardly from said seat portion, each of said arm rests being positionable in a stored position having each of said arm rests lying against said backrest portion;
a shelf being slidably coupled to said chair, said shelf being positionable in an extended position extending laterally away from said chair wherein said shelf is configured to assist the user to slide from said chair onto said upper surface of the bed; and
said shelf being slidably coupled to a bottom surface of said seat portion of said chair, said shelf being extendable laterally away from said seat portion in opposite directions when said shelf is positioned in said extended position, said shelf being positioned beneath said seat portion when said shelf is positioned in a stored position.

8. The assembly according to claim 2, further comprising a pair of pivots, each of said pivots being pivotally coupled to said cart, each of said pivots having a pair of first panels being spaced apart from each other to define a coupling space between said first panels, each of said pivots having a second panel extending away from each of said first panels, said second panel of each of said pivots being positioned in said slot in a respective one of said arms on said cart having each of said first panels of each of said pivots being horizontally oriented.

9. The assembly according to claim 8, further comprising a pair of first pins, each of said first pins extending laterally through a respective one of said arms and engaging said second panel in said slot in said respective arm such that each of said pivots is pivotable about said respective first pin.

10. The assembly according to claim 9, further comprising:
each of said members having a primary end and a secondary end, said secondary end of each of said members having a flattened section extending into said coupling space in a respective one of said pivots, each of said members being upwardly pivotable on said cart when said pivots are pivoted about said first pins, each of said members being laterally pivotable in said respective pivot; and
a pair of second pins, each of said second pins extending through said first panels of a respective one of said pivots and engaging said flattened section of a respective one of said members such that said respective member is pivotally coupled to said respective pivot.

11. A hospital bed lift assembly being configured to transfer a patient into and out of a hospital bed, said assembly comprising:
a cart being rollable along a support surface, said cart being positionable adjacent to a hospital bed and extending beneath the bed, said cart having a top surface and a front surface, said front surface having a pair of arms each extending forwardly therefrom, each of said arms having a distal end with respect to said front surface, said distal end of each of said arms having a slot extending toward said front surface;
a plurality of cart rollers, each of said cart rollers being rotatably coupled to said cart for rolling along the support surface;
a control circuit being coupled to said cart, said control circuit including a control panel having a plurality of buttons thereon, said plurality of buttons at least including an up button and a down button;
a lift being coupled to said cart, said lift being electrically coupled to said control circuit, said plurality of buttons controlling operational parameters of said lift, said lift comprising:
a sleeve having a first end and a second end, said first end being coupled to said top surface of said cart having said sleeve being vertically oriented;
a pole being slidably positioned in said sleeve, said pole having a top end and an outer surface, said top end being exposed with respect to said sleeve, said outer surface having a plurality of indentations thereon, said indentations being spaced apart from each other and being vertically distributed along said pole;
a motor being coupled to said cart, said motor being electrically coupled to said control circuit, said motor being turned on to rotate in a first direction when said up button on said control panel is manipulated, said motor being turned on to rotate in a second direction when said down button on said control panel is manipulated;
a gear being rotatably coupled to said motor such that said motor rotates said gear when said motor is turned on, said gear engaging said indentations in said pole, said pole being urged upwardly in said sleeve when said motor is actuated to rotate in said first direction, said pole being urged downwardly in said sleeve when said motor is actuated to rotate in said second direction; and
a power supply being coupled to said cart, said power supply being electrically coupled to said control circuit, said power supply comprising at least one battery;
a chair being pivotally coupled to said lift wherein said chair is configured to lift a user when the user sits in said chair, said chair being spaced above an upper surface of the bed when said chair is lifted wherein said chair is configured to facilitate the user to drop downwardly onto the upper surface of the bed when the user is transferred into the bed, said chair having a seat portion being pivotally coupled to a backrest portion, said backrest portion having attachments each being attached to said top end of said pole, said back rest portion being spaced forwardly from said pole having said back rest portion being vertically oriented, said seat portion being aligned with a lower edge of said backrest portion, said seat portion being positionable in a stored position having said seat portion lying against said backrest portion;
a pair of arm rests, each of said arm rests being pivotally coupled to said backrest portion of said chair, each of said arm rests being spaced upwardly from said seat portion, each of said arm rests being positionable in a stored position having each of said arm rests lying against said backrest portion;
a shelf being slidably coupled to said chair, said shelf being positionable in an extended position extending laterally away from said chair wherein said shelf is configured to assist the user to slide from said chair onto the upper surface of the bed, said shelf being slidably coupled to a bottom surface of said seat portion of said chair, said shelf being extendable laterally away from said seat portion in opposite directions when said shelf is positioned in said extended position, said shelf being positioned beneath said seat portion when said shelf is positioned in a stored position;
a pair of pivots, each of said pivots being pivotally coupled to said cart, each of said pivots having a pair of first panels being spaced apart from each other to define a coupling space between said first panels, each of said pivots having a second panel extending away from each of said first panels, said second panel of each of said pivots being positioned in said slot in a respective one of said arms on said cart having each of said first panels of each of said pivots being horizontally oriented;
a pair of first pins, each of said first pins extending laterally through a respective one of said arms and engaging said second panel in said slot in said respective arm such that each of said pivots is pivotable about said respective first pin;
a plurality of rollers, each of said rollers being rotatably coupled to said cart for rolling along the support surface;
a pair of members, each of said members being pivotally coupled to said cart, each of said members extending forwardly from said cart wherein each of said members is configured to inhibit the user from tipping said cart forwardly when the user is lifted in said chair, each of said members having a primary end and a secondary end, said secondary end of each of said members having a flattened section extending into said coupling space in a respective one of said pivots, each of said members being upwardly pivotable on said cart when said pivots are pivoted about said first pins, each of said members being laterally pivotable in said respective pivot;
a pair of second pins, each of said second pins extending through said first panels of a respective one of said pivots and engaging said flattened section of a respective one of said members such that said respective member is pivotally coupled to said respective pivot; and
a plurality of member rollers, each of said member rollers being rotatably coupled to and extending downwardly from a respective one of said members, each of said member rollers being aligned with said primary end of said respective member.
